(19) United States
(12) Patent Application Publication
(10) Pub. No.: US 2016/0059623 A1
(43) Pub. Date: Mar. 3, 2016

(54) SYSTEM AND METHOD FOR ANALYZING ROLLING STOCK WHEELS

(71) Applicant: LynxRail Corporation, Colorado Springs, CO (US)

(72) Inventor: Krzysztof Kilian, Colorado Springs, CO (US)

(21) Appl. No.: 14/837,173

(22) Filed: Aug. 27, 2015

Related U.S. Application Data
(60) Provisional application No. 62/042,592, filed on Aug. 27, 2014.

(51) Int. Cl. B60B 17/00; H04N 7/18

(52) U.S. Cl. CPC B60B 17/00; H04N 7/181

(57) ABSTRACT

An exemplary system and method for analyzing rolling stock wheels which helps allow a wheel to be analyzed at speed, reducing any need for manual inspections or other related delays. An exemplary system may include one or more high-speed cameras to capture images of the rolling stock wheel(s) at speed. The images may include one or more markers to assist in analyzing various parameters of the rolling stock wheel.

### RELATED APPLICATIONS

This application claims priority to U.S. Provisional Application 62/042,592, filed Aug. 27, 2014, which is incorporated herein by reference in its entirety.

### BACKGROUND

The present disclosure relates to a system and method for analyzing rolling stock wheels. The present invention more specifically relates to a system and method involving multiple cameras for measuring the parameters and/or profiles of such wheels.

For example, FIG. 1 illustrates a sectional view of a rolling stock wheel 100 on or atop a rail or rail head 110. Wheel 100 typically includes a rim 120 and a flange 130. Wheel 100 also typically includes a running surface 140, which generally includes a portion of rim 120 in contact with rail 110. Because wheels are known to move relative to a rail, running surface 140 of a wheel may be wider than a rail and may change over time and/or during the use.

For example, the rolling stock of a railroad, such as box cars, flat cars, tanker cars, hopper cars, gondolas, piggy back carriers for semi-tractor trailers and/or containers, passenger cars, and the like, are subject to wear, fatigue and the like. This is especially true of the wheels and trucks of such rolling stock. FIG. 2 illustrates a wheel profile 150 of a rolling stock wheel above a rail. Wheel profile 150 illustrated in FIG. 2 illustrates wear known as wheel hollowing. Wheel hollowing is generally considered a reduction in the thickness of the rim substantially near running surface 140 of wheel head 100.

Accordingly, it is typically necessary or desirable to inspect such rolling stock, and especially the trucks and wheels of such rolling stock, on occasion to help ensure that the rolling stock remains safe to use and is not likely to experience a breakdown (e.g., between the current inspection and the next inspection of that piece of rolling stock.

Traditionally, such inspections were performed manually. Not only were such manual inspections time consuming and expensive, it was difficult to ensure that a given piece of rolling stock was inspected on any reasonable or regular schedule.

Accordingly, as set forth in U.S. Pat. Nos. 6,911,914; 6,909,514; 6,872,945; 6,823,242; 6,768,551; 5,793,492; 5,677,533; 5,596,203; 5,448,072; 5,247,338; 3,253,140; and 3,206,596, each of which is incorporated herein by reference in their entirety. For its teachings, over the last thirty years, various systems and methods have been developed for automatically inspecting various aspects and parameters of railway rolling stock, such as railroad wheel and bearing temperatures, hot rail car surfaces, wheel profiles, and the like. Conventionally, such systems and methods have used passive sensors that generate a one-dimensional, time-varying signal as the piece of rolling stock passes by the sensor. To provide additional dimensional information, multiple sensors can be arranged either along or perpendicular to the railway rail. More recently, optical-based systems that generate two-dimensional images of various components of railway rolling stock, such as wheels, truck assemblies, car bodies of the rolling stock and the like, have been used to inspect such rolling stock.

Some optical-based systems provide for laser-based rolling stock wheel profile measuring systems. Such systems (often installed way side) typically derive wheel profile measurements by projecting laser lines onto a surface of the wheel and then capturing an image of the wheel surface with the laser line projected onto it. However, such known systems do not realize certain advantageous features (and/or combinations of features).

For example, the accuracy of measurements obtained using such laser systems is highly dependent on the calibration of the systems. Even minor changes in the setup and/or calibration may not be detectable immediately, therefore increasing the risk of unreliable data. Visual review or other manual processing of an object captured in the image is difficult because any image obtained using such systems is directed primarily to a projected laser line on the object, rather than an image of the object itself. As a result, any such processing is difficult, unreliable and has reduced value. For example, known systems typically derive certain wheel parameters (such as wheel hollowing) by assumption because the wheel parameter may not be clearly seen in images captured by such systems.

Such known systems often require correct calibration of the object to be measured. If the actual object being measured differs from the object that was calibrated, then errors are likely. Further, rolling stock wheels typically vary in size. Such variation typically requires interpolation and/or extrapolation, which may introduce errors.

Known laser-based systems can only be accurate for calibrated diameter wheels. As such, the accuracy of known laser-based systems tends to be overstated. For example, an image with a laser line overlaying a wheel head tends to lack accurate depth information. In addition, the angle of the laser line cannot be known precisely. Further, normalization of any kind is difficult and can contain errors because wheel shapes are irregular and variable due to manufacturing tolerances of the wheels. Also, the laser line crosses different portions of the wheel and the resultant line is a series of data points that rarely if ever references the same cross-section of the wheel.

The apparatus of such systems is typically subjected to vibration from passing rolling stock. Large vibrations may result in movement including relative movement between the laser line and the optical center of the image capturing apparatus. Such vibration and movements can lead to or result in errors.

The distance of the laser line on the wheel to the camera (making the laser line image) is also unknown or not sufficiently accurate to make accurate corrections. Such laser-based systems also do not adjust or account for the effect of the angle of attack and/or the effect of triggering inaccuracies.

Further, the laser line(s) of such known systems intended to overlay parent material of the rolling stock wheel may instead overlay foreign materials that are not part of the wheel (e.g. grease on the flanges from lubricators, etc.). Because typical processing algorithms assume that the laser line overlays only the parent material of the wheel, foreign material may negatively affect the accuracy and reliability of any measurements obtained from such systems.

The lasers of such known systems also present a potential safety hazard. While such systems typically include protective measures in the event of a system failure, such protective measures cannot eliminate the risk of laser exposure.

As a result, known laser-based systems are not extracting precise measurements and involve safety concerns. Accordingly, there is a need for a system and method for obtaining improved wheel and wheel set measurements are provided. Furthermore, the need for frequent calibration of laser-based systems adds to the costs of using the laser-based system technology for that purpose.

To overcome the disadvantages of laser-based systems, other optical wheel parameter measurement systems have been introduced such as, for example, the wheel parameters measurement systems disclosed in U.S. Pat. No. 7,714,886, the entirety of which is incorporated herein by reference.

Other known technologies have been utilized to further improve the accuracy of wheel parameters measurements. Such known technologies include U.S. Pat. No. 7,681,443, the entirety of which is incorporated herein by reference, which may be used for correcting any measurements that may be influenced by any angle of attack. A wheelset that has an angle of attack can have a negative effect on measurements. For example, as shown in FIG. 3 (which is an image of a flange on a wheel with no angle of attack) and FIG. 4 (which is an image of a flange of a wheel with an angle of attack of approximately 20 milliradians), various angles of attack may cause the width of a flange of wheel to appear thicker in a captured image than it is in the field. If the angle of attack is not removed or otherwise accounted or adjusted for, the measurement may be negatively affected. While in practical rail operation the influence of the angle of attack is not as pronounced as shown on the FIG. 4, angle of attack cannot be ignored for high precision measurements of wheel parameters.

As shown in FIGS. 5 and 6, component movement relative to a camera axis can also have a negative effect on the images of wheel components. Therefore, understanding the influence of wheel back face shift or spacing from the rail and being able to measure that shift or spacing accurately helps allow for correction and helps ensure that high precision measurements are performed. Such correction needs to be performed for any high precision measurement in dynamic environment (e.g., rolling stock with wheels traveling with speeds over 15 km per hour). Not being able to make such correction can make measurements inaccurate and/or difficult to repeat. The influence of angle of attack, lateral shift, dynamic movement of rail and other positioning situations may be corrected using known apparatus and methods in the above-referenced and incorporated patents.

Other optical wheel parameter measurement systems have been introduced such as, for example, the wheel parameter measurement systems disclosed in U.S. Pat. No. 8,829,526, the entirety of which is incorporated herein by reference. FIGS. 7-13 help illustrate an example known apparatus and method of wheel parameter measurement. FIG. 7 illustrates a wheel parameter measurement system that includes at least two track or gage side cameras 221/223 and a field side camera 225 directed toward a rail 213 that may be used to capture in images (such as those illustrated in FIGS. 8-10) portions of vital segments of a wheel 250 which also include reference markers 270 attached to rail 213 at the system installation. The partial curves illustrated in FIGS. 11-13 are derived from the images in FIGS. 8-10. More specifically, such images capture the portion of wheel 250 in its real positioning relative to each camera's view. Using reference markers 270, the wheel position is established with the reference to the top of rail 213. An accurate angle of attack of the wheelset is measured from the wheel sensors as disclosed in the U.S. Pat. Nos. 7,278,305 and 7,681,443 and/or from the images captured. The precise relationships of the cameras and the images are utilized to correct and/or normalize the derived portions of the curves to be suitable to use for measurements of the wheel parameters. If the analysis would not allow for determination of exactly the position of the wheel when the image is captured, it would be difficult to remove, adjust or account for the above-mentioned influences.

The wheel curves shown in FIG. 11 and FIG. 12 are referenced to the top of railhead for complete construction and/or derivation of the wheel profile curve. FIG. 13 illustrates an accurate railhead profile that is used in the process of construction of the final wheel curve. The railhead is measured accurately at the system commissioning and its digital trace is used during the process. More specifically, the following processes may be followed:

The corrected final portions of the wheel curves derived from the analysis as shown on FIGS. 11 and 12 are assembled into final construction with the rail profile as shown in FIG. 13. For simplicity and purposes of illustration, each point of the wheel profile and rail profile curve is drawn using X and Y coordinates. Furthermore the imager of the camera has a matrix of pixels that have also XY coordinates. In final construction of the wheel profile curves, all of the information is referenced to the same coordinates.

From physics of the rail and wheel interaction we know that the shape of the wheel (the curve) will have, in most cases, only a small number of permissible contact point(s) with the known railhead profile. The number of contact points will depend on the finally derived curves. However, from knowledge of the wheel and rail interaction, the area of the wheel in contact with rail tends to be very small for the wheel to travel at high speeds.

Knowing the contact points of the rail, we also know the contacts point on the wheel curve that need to be constructed theoretically because they are not clearly visible in any images captured by any of the cameras of the known system. However, the wheel does not typically penetrate the railhead and, using this fact, the method produces accurate reliable and repeatable results.

From FIG. 11, the most right point of the profile curve of the visible portion of the wheel is the starting point of the unknown, to-be-determined, less visible or invisible portion of the profile.

From FIG. 12, the most left point of the profile curve of the visible portion of the wheel is the end point of the less visible or invisible portion of the profile.

From FIG. 13, the less visible or invisible portion of the wheel profile must not be lower than the top of the railhead and it will have to be well matched with possible contact points along the top of the railhead (the rail profile curve). The less visible or invisible portion of the wheel curve is typically derived from curve fitting. The matching of the curves (e.g., using an algorithm) may be used to derive the best fit curve to fulfill the assumptions.

From use of the markers that are fully fixed to the rail and present in each of the images shown as FIGS. 8-10, the wheel parameters can be measured with the proven accuracy of +/−0.5 mm. As a result, this section of the wheel profile (as shown on FIG. 13) has the above-stated accuracy and it is derived from curve fitting.

The wheel parameters may be measured from a tape line of the wheel (which is 70 mm from the back face of the wheel for majority of standards worldwide).

In first step, all cameras are typically calibrated using the calibration fixture to establish the measurement resolution per pixel for each camera. Once so calibrated, the system is ready for final calibration and fine tuning.

As the installation is carried out in static conditions on the railway track there is no possibility to account for how the system will perform during the train movements over that section of the track. Therefore, in the second step, the (installation) location characteristics have to be established. The rail may move up and down and from side to side as well—there will likely be some twist in the rail during the train going over the system and these movements will have to be quantified and accounted for in the dynamic environment. Even though the system with markers helps eliminate all the dynamic effects from the influence on the measurements, the triggering is based on high precession timing of electronic sensors that are attached to the rail in such a way as to sense each wheel that is passing through the system. The sensor array that is used for capturing all the wheels and then used for developing strategies for triggering the cameras is independent of the optical system. The sensors and their accuracy of sensing the wheels depend on their physical installation. As a result, dynamic calibration of the system is required to fine tune the system and confirm the ability to correctly measure the wheel profiles with the known wheel profiles and wheel parameters.

That is why several wheelsets are measured in static conditions with high precision instruments within accuracy of 0.01 mm-0.1 mm (the practical accuracies of these instruments accounting for a deviation from operator to operator in the setup will create some errors but the accuracy of measurements should be better than 0.1 mm) One such instrument currently available for railways is the Miniprof from Greenwood Engineering in Denmark and it is currently regarded as the most accurate for wheel profile trace and measurements.

In the final calibration and fine tuning and the system commissioning, it is a requirement that the wheelsets in various stage of wear (from new to very worn are part of the calibration set) are on the passing train through the system installation. It is not pre-requisite to have many wheelsets but a minimum of two wheelsets are recommended to be used for the finalization of the process. The accuracy of the setup will improve with the bigger sample of wheels with known profiles to be included in the system initial setup and fine tuning When the train passes via the system these wheels are analyzed (e.g., via various algorithms) from their images (similar as on FIGS. 8-10) and the results compared with manual static measurements and the setup is adjusted and fine-tuned and the system is finalized and commission for production.

The incompressibility between the rail and the wheel makes the system reliable and repeatable. As illustrated in FIG. 13, the best fit between the unknown wheel profiles and known rail profile has some level of uncertainty; however, with an understanding of wheel profile continuity, the “missing” section of the wheel profile curve can be confidently completed with some estimated shape.

The described method used in the known wheel parameters measurements system has been proven accurate to within a maximum error of +/−0.5 mm. This has been confirmed with the system producing data with that accuracy for over twelve years. In the USA, the known system was classified as producing the data with accuracy of +/−1 mm to account also for the variability of the wheels, producing data with solid reliability and repeatability of measurements.

For the known wheel parameters measurements system, the less visible or invisible portion of the wheel profile curve is derived (e.g., using the above-mentioned algorithms) with accuracies of +/−1 mm confidently. However, this tolerance can reduced to +/−0.5 mm for the known wheel parameters measurements system if a database of known profile curves is used. When a more comprehensive database of wheel profile curve within various stages of wheel wear is used, the accuracy of selection of the correct profile overlay will result in more accurate dimensional measurements of the wheel profile. The best fit selection of the appropriate wheel wear curves provides a basis for minimal error in measurements of wheel parameters and most accurate known wheel profile curve.

Still, some railway industry specialists view the known optical wheel parameters measurement system deriving the less visible or invisible portion of the wheel profile curve as insufficiently accurate enough for measuring or determining the wheel's true profile. Even though the system is capable of measuring the parameters with very good accuracies of +/−0.5 mm after careful setup, the inability to physically capture or see a portion of the wheel section has prevented full acceptance of the known system by the rail industry.

As such, some in the rail industry have instead continued to utilize laser-based wheel profile measurement systems, which capture photos of one or more laser lines overlaying the wheel profile. As discussed above, such laser-based wheel profile measurement systems have short comings and there is a need for an improved system and method for obtaining improved wheel and wheel set measurements, and particularly an improved optical system and method for obtaining improved wheel and wheel set measurements.

It would be desirable to provide a system, method or the like for capturing, measuring and/or analyzing rolling stock wheel parameters of the type disclosed in the present application that includes any one or more of these or other advantageous features: a system and/or method that does not substantially depend upon detailed calibration of the system or of the object to be measured; a system and/or method that is affected little by foreign materials that are not part of the original rolling stock wheel; a system and/or method that does not utilize lasers and thereby eliminates the risks of exposure to such lasers; and a system and/or method that does not need to derive wheel parameters by assumption but instead may accurately measure complete wheel parameters including wheel hollowing.

Such systems and methods for capturing, measuring and/or analyzing rolling stock wheel parameters would be advantageous for a number of reasons. These reasons include allowing the systems, or inspection stations that utilize such systems, to be located at points where most rolling stock is likely to be inspected at reasonable intervals, such as the entrances or exits to rail yards, without having to significantly involve railroad personnel in the actual inspection. Furthermore, such systems and methods are designed to inspect the rolling stock at speed. That is, the inspection can occur while the rolling stock moves at its normal rate of travel past the inspection station. In contrast, manual inspections typically require the rolling stock to be stopped to allow the railway personnel access to the various components to make the measurements. By allowing the rolling stock to move at speed through the inspection station, the inspection can occur without substantially negatively affecting the schedule of a particular train, thus reducing the cost of the inspection and delays in transporting goods.

Additionally, such systems and methods would avoid several limitations and/or disadvantages of laser-based systems, and/or are inherently safer than laser-based systems.

### SUMMARY

The present invention relates to a system for capturing, measuring and analyzing rolling stock wheel parameters, comprising: a first flange camera provided between a first rail and a second rail, wherein the first flange camera is positioned to capture an image of at least a portion of a flange of a first wheel, the flange being located between said first rail and said second rail; a first internal rim camera provided between said first rail and said second rail, wherein the first internal rim camera is positioned to capture an image of at least a portion of said first wheel; a first flange throat camera provided between said first rail and said second rail, wherein the first flange throat camera is positioned to capture at least a portion of a flange and area of wheel profile near a flange throat of said first wheel; a first outer rim camera provided outside the area between said first rail and said second rail, wherein the first outer rim camera is positioned to capture an image of at least a portion of a running surface of said first wheel; a first field side camera provided outside the area between said first rail and said second rail, wherein the first field side camera is positioned to capture an image of at least a portion of a field side of said first wheel; and a first endcap camera provided outside the area between said first rail and said second rail, wherein the first end cap camera is positioned to capture an image of at least a portion of an endcap of said first wheel.

The present invention relates to a method of capturing, measuring and analyzing rolling stock wheel parameters, comprising: capturing, with a first flange camera provided between a first rail and a second rail, an image of at least a portion of a first wheel on said first rail having a flange provided between said first rail and said second rail; capturing, with a first internal rim camera provided between said first rail and said second rail, an image of at least a portion of said first wheel; capturing, with a first flange throat camera provided between said first rail and said second rail, an image of at least a portion of a flange and area of wheel profile near a flange throat of said first wheel; capturing, with a first outer rim camera provided outside the area between said first rail and said second rail, an image of at least a portion of said first wheel, including at least a portion of a running surface of said first wheel; capturing, with a first field side camera provided outside the area between said first rail and said second rail, an image of at least a portion of a field side of said first wheel; and capturing, with a first endcap camera provided outside the area between said first rail and said second rail, an image of at least a portion of an endcap of said first wheel.

The present invention relates to a method of providing a system for capturing, measuring and analyzing rolling stock wheel parameters, comprising: positioning and orienting a first flange camera between a first rail and a second rail to capture an image of at least a portion of a first wheel having a flange provided between said first rail and said second rail; positioning and orienting a first internal rim camera between said first rail and said second rail to capture an image of at least a portion of said first wheel; positioning and orienting a first flange throat camera between said first rail and said second rail to capture an image of at least a portion of a flange and area of wheel profile near a flange throat of said first wheel; positioning and orienting a first outer rim camera outside the area between said first rail and said second rail to capture an image of at least a portion of said first wheel, including at least a portion of a running surface of said first wheel; positioning and orienting a first field side camera outside the area between said first rail and said second rail to capture an image of at least a portion of said first wheel; and positioning and orienting a first endcap camera outside the area between said first rail and said second rail to capture an image of at least a portion of an endcap of said first wheel.

These and other features and advantages of various exemplary embodiments of systems and methods according to these inventions are described in, or are apparent from, the following detailed descriptions of various exemplary embodiments of various devices, structures and/or methods according to this invention.

### BRIEF DESCRIPTION OF DRAWINGS

Various exemplary embodiments of the systems and methods according to this invention will be described in detail, with reference to the following figures, wherein:

FIG. 1 is a sectional view of a portion of a wheel on a rail head.

FIG. 2 is a partial sectional view of a wheel profile of a rolling stock wheel positioned on a rail.

FIG. 3 illustrates an image of a wheel flange with no angle of attack and reference marks of a known wheel parameters measurements system.

FIG. 4 illustrates an image of a wheel flange with 20 milliradians angle of attack and reference marks of a known wheel parameters measurements system.

FIG. 5 illustrates an image of a wheel flange with 50 mm of back face of a wheel from a rail and reference marks of a known wheel parameters measurements system.

FIG. 6 illustrates an image of a wheel flange with 70 mm of back face of a wheel from a rail and reference marks of a known wheel parameters measurements system.

FIG. 7 is a top view of an example of a known system for capturing, measuring and/or analyzing rolling stock wheel parameters.

FIG. 8 illustrates an image of a flange of a wheel and reference markers captured by the known wheel parameters measurements system of FIG. 7.

FIG. 9 illustrates an image of an internal rim of a wheel and reference markers captured by the known wheel parameters measurements system of FIG. 7.

FIG. 10 illustrates an image of an outer rim of a wheel and reference markers captured by the known wheel parameters measurements system of FIG. 7.

FIG. 11 illustrates a representation of a flange and a portion of a wheel profile, and a portion of a rail profile, derived using the images of FIGS. 8 and 9.

FIG. 12 illustrates a representation of an outer rim of a wheel profile and a portion of a rail profile derived using the image of FIG. 10.

FIG. 13 illustrates a representation of portion of a wheel profile derived using FIGS. 11 and 12 and a portion of a measured rail profile.

FIG. 14 illustrates a top view of a system for capturing, measuring, and/or analyzing rolling stock wheel parameters, according to various examples of embodiments.

FIG. 15 illustrates an isometric view of various cameras of a wheel parameters measurements system according to various embodiments that may be utilized to capture an image such as that illustrated in FIGS. 22 and 23.

FIG. 16 illustrates a top view of a wheel parameters measurements system according to various embodiments that may be utilized to capture image such as those illustrated in FIGS. 20, 21 and 24.

FIG. 17 illustrates a field side view of the wheel parameters measurements system shown in FIG. 16 that may be utilized to capture images such as those illustrated in FIGS. 20 and 24.

FIG. 18 illustrates an image of an internal rim of a wheel and reference markers captured by a wheel parameters measurements system according to various embodiments.

FIG. 19 illustrates an image of a flange of a wheel and reference markers captured by a wheel parameters measurements system according to various embodiments.

FIG. 20 illustrates an image of an outer rim of a wheel captured by a wheel parameters measurements system according to various embodiments.

FIG. 21 illustrates an image of a flange and area of wheel profile near flange throat captured by a wheel parameters measurements system according to various embodiments.

FIG. 22 illustrates an image of an outer rim of a wheel and reference marker captured by a wheel parameters measurements system according to various embodiments.

FIG. 23 illustrates an image of an end cap of a wheel captured by a wheel parameters measurements system according to various embodiments.

FIG. 24 illustrates an image of a running surface of a wheel captured by a wheel parameters measurements system according to various embodiments.

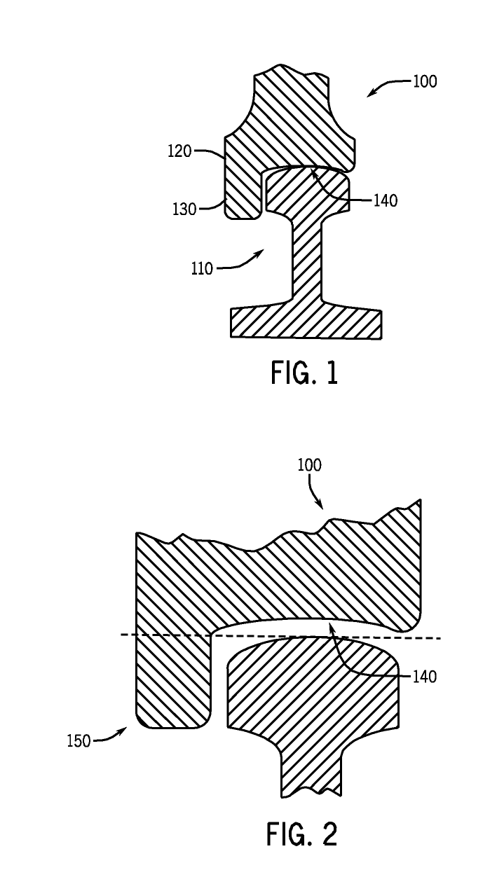

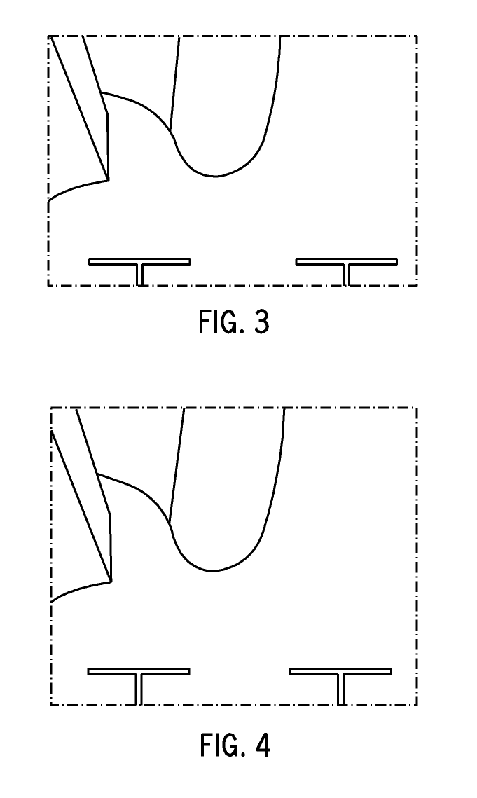

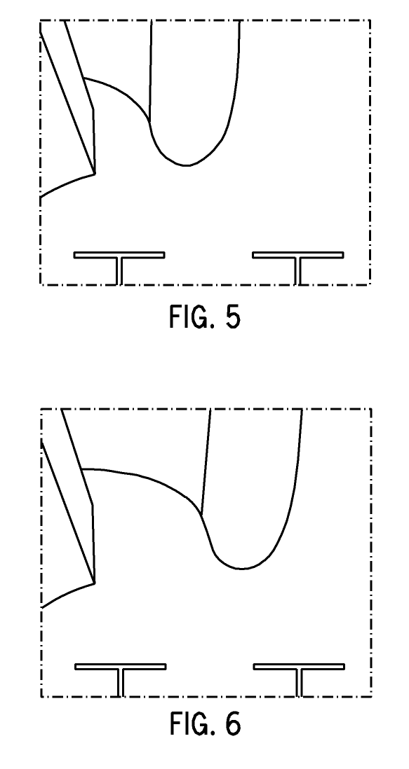

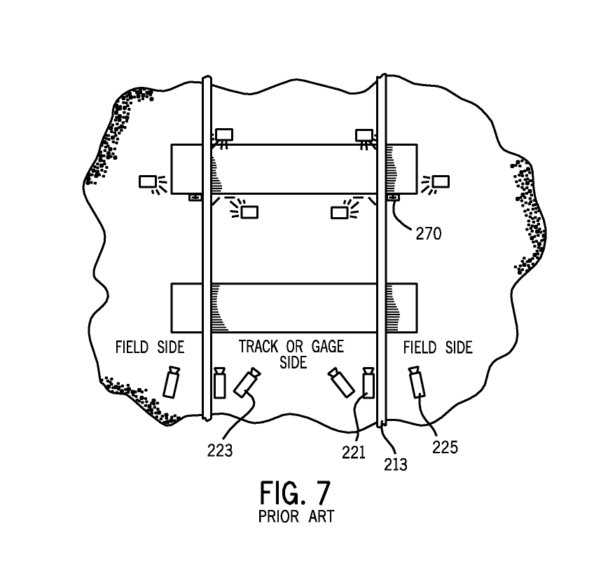

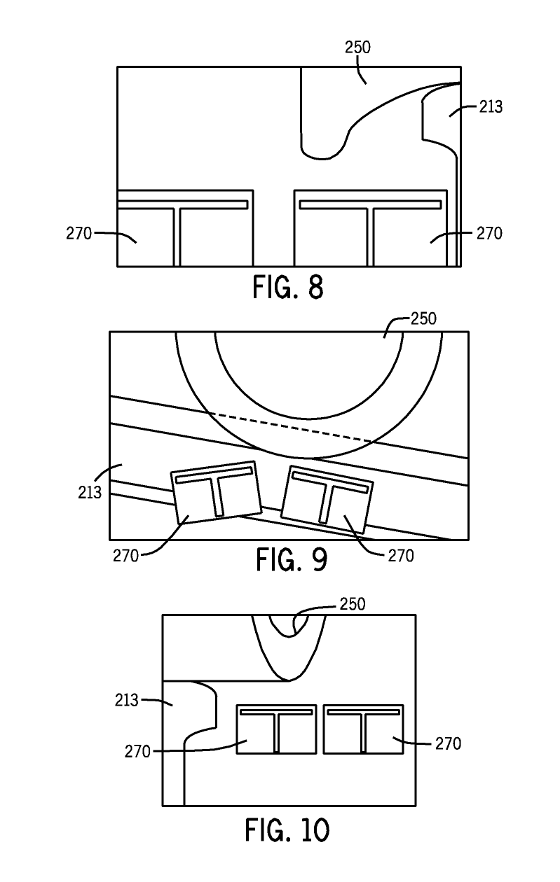

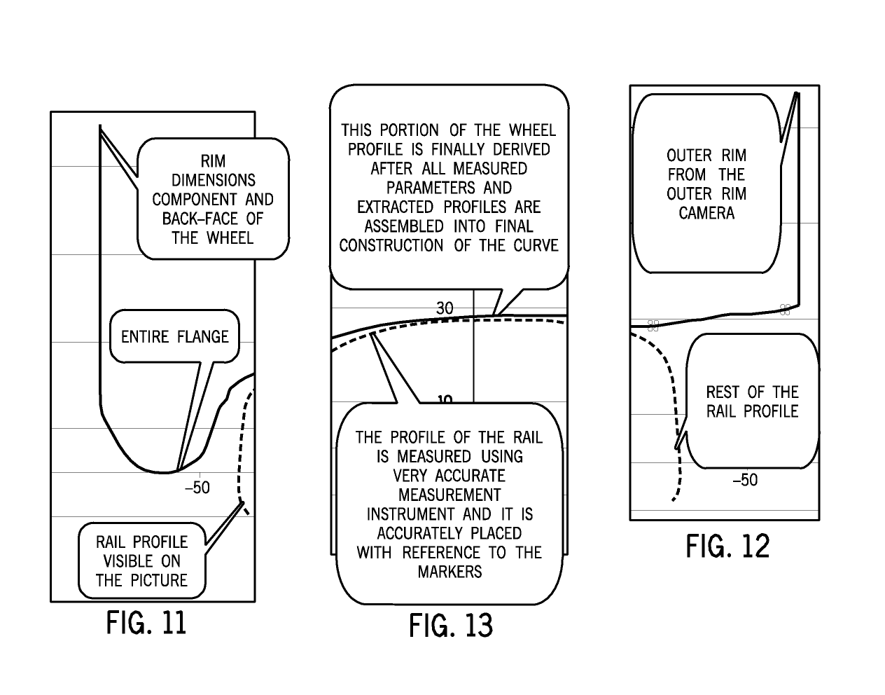

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

A railroad can own tens of thousands, if not more, of pieces of rolling stock. Such rolling stock includes both locomotives and freight and/or passenger cars. Typically, a railroad owns dozens of different types of freight cars, such as box cars, tanker cars, gondolas, hoppers, flat cars, piggy-back flat cars, container carriers, livestock cars and the like. If a railway provides passenger service, the rolling stock can contain passenger cars, baggage cars, mail cars, sleeper cars, dining cars, observation cars and the like. Inspecting rolling stock is typically problematic (e.g. due to its mobile nature). Accordingly, as outlined in the above-incorporated U.S. patents, automatically inspecting rolling stock as it passes by an inspection station can be more efficient than manually inspecting the rolling stock.

As outlined above, while manually inspecting the rolling stock can provide very precise and accurate measurement of various parameters associated with the rolling stock, such manual measurements are time consuming and expensive. Not only does manual inspection require trained personnel, manual inspection requires stopping a train containing the rolling stock for a period of time. Because railways earn profits by moving goods from one place to another, delays for inspecting the rolling stock can negatively impact the railway (e.g. directly reduce the profits earned by the railway).

In various embodiments, systems including machine vision absent any laser lines are utilized due to known disadvantages of laser line technology and systems. Laser-based systems unnecessarily complicate wheel profile measurements and increase the risk of erroneous measurements. Further, the laser-included systems also present a potential safety hazard (risk of laser exposure in the case any protective system fails).

In various embodiments, the system related to the present disclosure utilizes high-speed cameras (without lasers) to capture parameters of rolling stock wheels. In various embodiments, the system provides accurate measurements of the complete profile and wheel head of the wheel, including wheel hollowing measurements. The system does not require assumptions to derive wheel parameters, but uses parameters captured from images, thereby improving the maintenance practices of the railroads by providing railroad operators with a reliable and easy-to-maintain wheel profile and wheel parameter measuring system, and increasing the safety of railroad operations. In addition, the system is capable of measuring all wheels of a various rolling stock traveling at normal speeds (e.g., at least 60 miles per hour).

In various embodiments, optical cameras (e.g., digital optical cameras) are added to the known optical wheel profile and wheelset parameters measurement system disclosed in U.S. Pat. No. 7,714,886 and U.S. Pat. No. 8,289,526, each of which are incorporated by reference in their entireties, to further improve the determination and/or accuracy or perceived accuracy in wheel and wheelset parameters measurements. In various embodiments, one or more additional cameras are strategically provided or positioned to allow all pertinent parts of the wheel and wheelset to be captured.

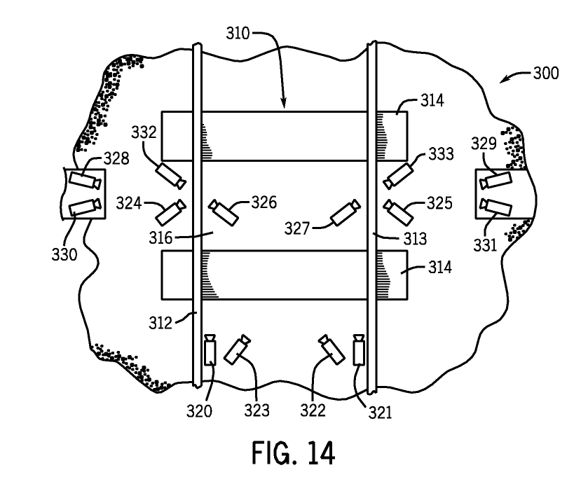

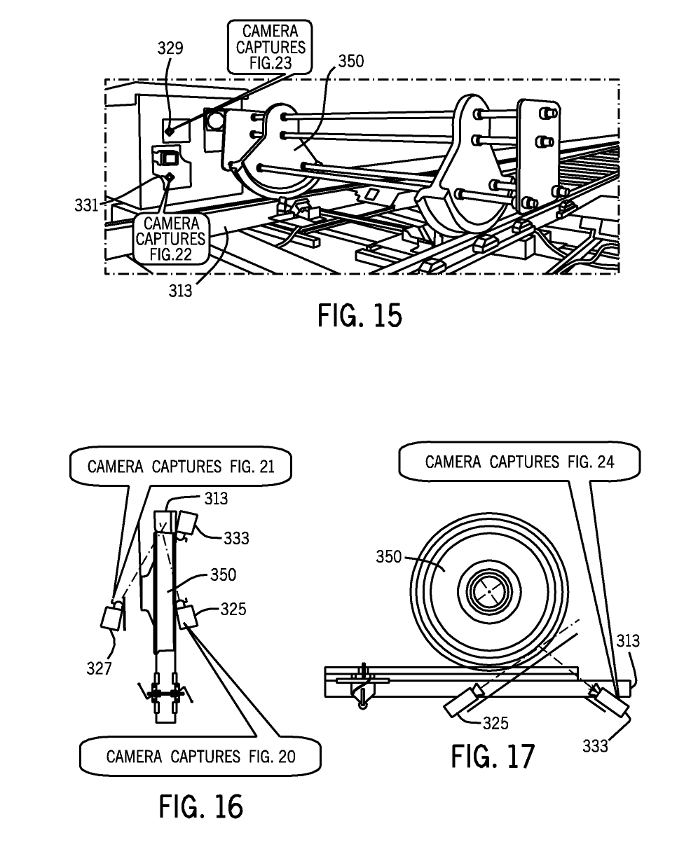

For example, in various embodiments and referring to FIG. 14, a field side camera (e.g., a second field side camera) 329 is provided and positioned to capture an image of the field side of a wheel and a reference marker such as that shown in FIG. 22. The field side camera for capturing an image of the field side of a wheel and (and optionally a reference marker) such as that shown in FIG. 14 may capture an image such as shown in FIG. 22 which may be utilized for improved wheel parameter measurements, wheel diameter measurements, calibration and/or normalization of measurement of both rim and wheel diameter.

As another example, in various embodiments and referring to FIG. 14, an outer rim camera (e.g., a second outer rim camera 325) is provided and positioned to capture an image of the running surface and/or wheel profile, such as that shown in FIG. 20, which may be utilized to measure and extract the portion of the wheel profile that is not currently captured or adapted to be captured using just the standard wheel profile system. In various embodiments, the image provides a real image of the running surface of the wheel, and the shape of the wheel profile may be processed (e.g., using digital image processing algorithms) or otherwise determined Because the known wheel profile systems disclosed in U.S. Pat. Nos. 7,714,886 and 8,289,526 provide most of the parameters with high accuracy, the addition of the accurate wheel diameter measurements allows all the shapes and the dimensions to be normalized to within fraction of the millimeter. As a result, high or higher accuracy is achieved and any further improvement in accuracy is likely a matter of requirements as the entire wheel shapes are captured by the additional cameras.

As another example, in various embodiments and referring to FIGS. 14 and 23, an end cap camera (e.g., a second end cap camera 331) is provided and positioned to capture an image of the center of the axle or end cap such as that shown in FIG. 23. The camera 331 for capturing an image of the center of the axle or end cap such as that shown in FIG. 23 may capture an image which may be utilized to extract or determine the center of the axle and the wheel with high precision. For example, accurate measurements of the center of each wheel may be derived when combined with the standard wheel parameters measurements to accurately determine each wheel diameter.

FIG. 14 illustrates an exemplary embodiment of an inspection station 300, as a system for capturing, measuring and/or analyzing rolling stock wheel parameters, according to this disclosure. As shown in FIG. 14, in various exemplary embodiments, inspection station 300 comprises a section 310 of track where a variety of image capture devices, including a first flange camera 320, a second flange camera 321, a first internal rim camera 322, a second internal rim camera 323, a first outer rim camera 324 and the second outer rim camera 325, a first flange throat camera 326, a second flange throat camera 327, a first field side wheel camera 328, the second field side wheel camera 329, a first end cap camera 330, and the second end cap camera 331, are provided. In various embodiments, a first wheel running surface camera 332 and a second wheel running surface camera 333 are also provided. In various exemplary embodiments, inspection station 300 may also include strobe lighting and one or more triggering systems in communication with one or more cameras and/or the strobe lighting. The system may also include one or more data processing units and/or one or more communication links in communication with at least one of the cameras.

As also shown in FIG. 14, in one embodiment, section 310 of track includes portions of a first rail 312 and a second rail 313 that are provided on one or more sleepers 314. Sleepers 314 may be embedded in a mass of ballast 316. Rails 312, 313 may be coupled to sleepers 314 using any known or later-developed technique and/or device. As shown in FIG. 14, image capture devices may be located outside one or both of rails 312, 313 (i.e., located to a field side of one or both rails 312, 313) and/or between rails 312, 313 (i.e., located on a gage or track side of rails 312, 313).

In various exemplary embodiments, the various image capturing devices, such as cameras 320-331 shown in FIG. 14, utilized in the system are positioned and/or angled to capture at least portions of wheel heads of wheels of one or more wheel sets. In various exemplary embodiments, the various image capturing devices utilized in the system may also be positioned and/or located to help magnify one or more captured objects.

More specifically, in various exemplary embodiments, first flange camera 320 and second flange camera 321 are provided (e.g., located and positioned) adjacent the track side of first rail 312 and second rail 313, respectively, and pointed substantially at a flange of a first wheel and a flange of a second wheel of a wheel set, respectively, and located and positioned so that the wheel set may pass without contacting either camera 320, 321.

Likewise, in various exemplary embodiments, first internal rim camera 322 is provided between first rail 312 and second rail 313 (e.g., adjacent the track side of second rail 313) and oriented (e.g., at a slightly vertical angle and horizontal angle) to allow first internal rim camera 322 to capture an image of at least a portion of a rim of the first wheel, while second internal rim camera 323 is provided between first rail 312 and second rail 313 (e.g., adjacent the track side of first rail 312) and oriented (e.g., at a slightly vertical angle and horizontal angle) to allow second internal rim camera 323 to capture an image of at least a portion of a rim of the second wheel.

In various exemplary embodiments, first outer rim camera 324 and second outer rim camera 325 are provided to the field side of first rail 312 and second rail 313, respectively, and oriented (e.g., at a slightly vertical angle and horizontal angle) to allow first outer rim camera 324 and second outer rim camera 325 to capture an image of at least a portion of the wheel profile of a first wheel and at least a portion of the wheel profile of a second wheel, respectively.

In various exemplary embodiments, first flange throat camera 326 and second flange throat camera 327 are provided to the track side of first rail 312 and second trail 313, respectively, and oriented (e.g., at a slightly vertical angle and horizontal angle) to allow first flange throat camera 326 and second flange throat camera 327 to capture an image of at least a portion of the flange, and the area of the wheel profile that is near the flange throat, of a first wheel and at least a portion of the flange and the area of profile that is near the flange throat of a second wheel, respectively.

In various exemplary embodiments, first field side camera 328 and second field side camera 329 are provided to the field side of first rail 312 and second rail 313, respectively, and oriented to allow first field side camera 328 and second field side camera 329 to capture an image of at least a portion of the field side of a first wheel and the field side of a second wheel, respectively. The images captured by the first field side camera 328 and second field side camera 329 may be used to aid in the accuracy of the wheel profile measurements and the wheel diameter measurements, especially with the markers that may be provided and captured in the same images.

In various exemplary embodiments, first end cap camera 330 and second end cap camera 331 are provided to the field side of first rail 312 and second rail 313, respectively, and oriented to allow first end cap camera 330 and second end cap camera 331 to capture images of at least a portion of the center of the wheel or wheel set to improve the accuracy of wheel diameter measurements. In various embodiments, first wheel running surface camera 332 and second wheel running surface camera 333 are also provided to the field side of first rail 312 and second rail 313, respectively, and oriented to allow first wheel running surface camera 332 and second wheel running surface camera 333 to capture at least a portion of the running surface of a first wheel and a second wheel, respectively. The images captured by first wheel running surface camera 332 and second wheel running surface camera 333 are optional but may be utilized to assess the condition of the wheel surface.

It should be appreciated that the image capturing devices may be positioned, oriented and aligned any number of ways. In various exemplary embodiments, however, the image capturing devices are positioned, aligned and oriented to help allow the image capturing devices to capture precisely an area of interest, e.g., the majority of a wheel's profile.

It should also be appreciated that the various image capturing devices, such as cameras 320-333, can be implemented by incorporating one or more physically distinct imaging systems, such as complete digital cameras, into an image capture device body. In one embodiment, the various image capturing devices can be implemented as a plurality of physically independent image capture systems, such as complete digital cameras. In one embodiment, the various image capturing devices can implement one or more imaging systems using physically distinct lens assemblies and image capture electronics, with common data storage, input/output control and other electronics. It should be appreciated that any known or later-developed type or types of image capture systems may be used to implement any one of or multiple ones of the various image capturing devices, including cameras 320-333.

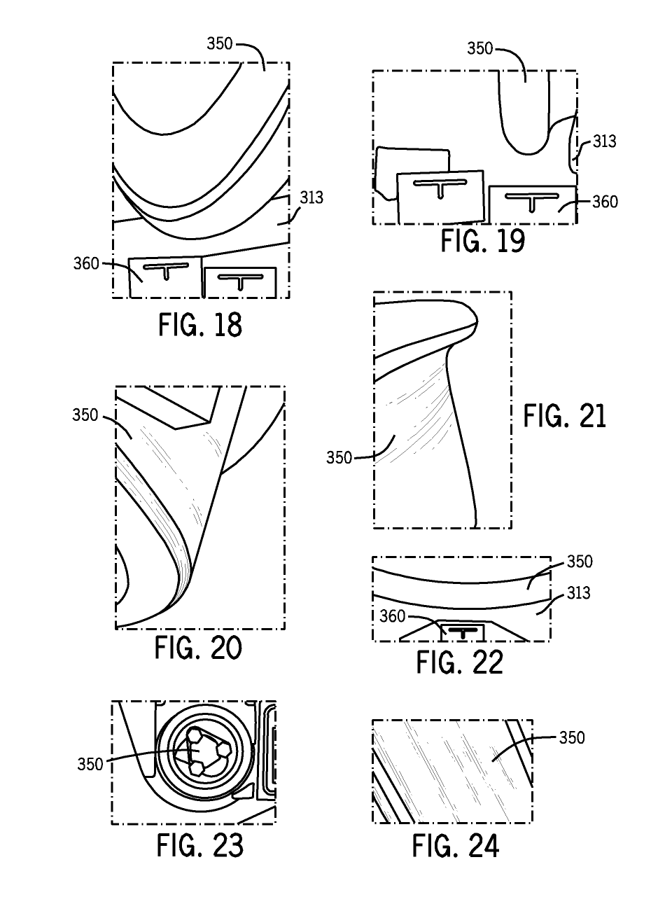

FIGS. 18-24 illustrate various images that may be captured by cameras of the system intended to capture images of one or more wheels 350 positioned substantially above, for example, second rail 313 (e.g., the second flange camera, the second internal rim camera, the second outer rim camera, the second flange throat camera, the second field side camera, the second end cap camera, and the second wheel running surface camera). For example, as shown in FIGS. 18-24, the majority of a profile of a wheel 350 may be viewable and/or measurable utilizing images produced by the second flange camera, the second internal rim camera, the second outer rim camera, the second flange throat camera, the second field side camera, the second end cap camera, and the second wheel running surface camera. More specifically, as depicted in FIG. 20, at least a portion or representative sample or section of an entire running wheel profile of wheel 350 should be visible from the location of an outer rim camera (e.g., the second outer rim camera).

As shown in FIGS. 18-19 and 22, the system may also include one or more markers 360 provided about the first and/or second rails, such as those markers disclosed in previously incorporated by reference U.S. Pat. No. 7,714,882. Because such markers 360 may be included in one or more images captured by the system, the correct interrelationships of the images may be more easily determined and, as a result, accurate measurements of the wheel parameters and the wheel profile may be obtained.

More specifically, markers 360 may be located in areas to be captured in the images to enable referencing to the top of the rail or to each of the images. This may ensure more accurate measurements of the wheel parameters (including wheel hollowing) and the wheel profile.

The system of the present invention may also include one or more sensors (not shown), such as those disclosed in U.S. Pat. No. 7,278,305, which is incorporated herein by reference in its entirety. Such sensors may be used to determine the existence of any speed variations of each wheel set on a train. In addition, such sensors may be used to improve the timing of the cameras and help ensure that all images are timely captured. Further, where the distances from the cameras to the captured objects are known, all measurements may be corrected for any angle of attack or tracking of the captured objects.

The system may also include one or more backface illumination plates provided between the first rail and the second rail (e.g., adjacent the track side of the first rail and/or the second rail) and oriented to reflect light toward the flange and/or rim of one or more wheels traveling along the first rail and/or the second rail. For example, the backface illumination plates may be mounted vertically and oriented toward the camera or a respective camera ten to fifteen degrees relative to the general longitudinal direction of the rail. In various embodiments, the backface illumination plates are provided to avoid contact with any of the wheels. Further, in various embodiments, any backface illumination plates may be flexibly mounted (e.g., spring-mounted) so that if it is contacted by the wheel or any components or equipment of rolling stock, it may flex and/or give way and substantially return to its original and/or optimal position. Each backface illumination plate may be constructed of any type of material. In various embodiments, the backface illumination plates are constructed of at least a surface material having reflective characteristics.

In various embodiments, the one or more additional cameras allow a user to gather information on a relatively complete portion of the wheel. In addition, in various embodiments, the additional cameras allow for improved accuracy of the measurements on all wheel/wheelset parameters.

In various embodiments, the additional cameras overcome the limitations or perceived limitations of the known optical wheel parameters measurement systems and increase the accuracy of the parameter determinations or measurements. Further improvement in accuracies is achieved by: (a) additional cameras; (b) capturing reference markers on images with the additional cameras; (c) referencing all the cameras and/or images captured by the cameras to each other to determine the composite wheel head of each wheel; and/or extending the geometrical relationships between the cameras and the line cameras to be able to “tie” all the pictures into one 3-D geometrical model of the wheel and the entire wheelset.

In various embodiments, the new or additional views captured by the additional cameras, and/or tying or virtually tying some or all the images of the wheel/wheelset to the rail or railhead, and/or the use of mathematical and geometrical equations and relationships, improves the accuracy of measurements for various parameters of the wheel and wheelset, and allows accurate derivation, measurement and/or determination of the complete or substantially complete shape of the wheel profiles. In addition, in various embodiments, the use of reference markers optimizes the system for the dynamic environment of railways. The digital processing algorithms tying the images together can also help keep the system self-reliant. In various embodiments, the measurements are normalized and the accurate information regarding the position of the wheel during the time when the images of the wheel and/or wheelset are captured enables the determination, calculation and/or measurement of the wheel profile and wheelset parameters. The ability to remove or otherwise adjust for the effect of the wheel position relative to a rail (e.g., the angle of attack, distance from the rail, etc.) can make the measurements with high degree of accuracy estimated closer than +/−0.3 mm.

In various embodiments, the cameras are provided or positioned, and triggered concurrently or in synchronization, to allow (e.g., using an algorithm) for cross correlation of all the markers and all images for each wheel and the wheelset. In various embodiments, advanced processing algorithms extract confidently the key elements that are used in algebraic equations and geometrical dependencies. In various embodiments, the images including reference markers allow confident and accurate measurements of the wheel and wheelset even with dynamic motion and vibration from passing trains, movement of a rail, etc.

In various embodiments, an image of the running surface profile is captured accurately (e.g., with accurate timing). In various embodiments, the profile that is visible on the image is referenced to the wheel dimensions that are measured with high precision and therefore the profile can be accurately normalized to complete all the measurements of the wheel profile with high precision and reliance on the derivation step utilized in the standard wheel profile as shown in FIG. 13. In various embodiments, five (or six) pictures per wheel (and/or ten (or twelve) pictures per axle) are used to accurately measure or otherwise determine all desired and/or required parameters for wheel and wheelsets. In various examples of embodiments, the full wheel profile curve is determined with a high degree of accuracy using the captured images.

The area of the picture illuminated by a strobe or flash light can be also supplemented by an additional camera to take the picture of the surface of running wheel and using the previously disclosed technology in U.S. Patent Pub. No. 20120194665, the entirety of which is hereby incorporated herein by reference, extract any surface defects on the wheel surface like shelling, gauging or other surface wheel defects in that area of the photo.

It should be appreciated that black and white, color, or any camera or imager, including without limitation an RGB (red-green-blue) imager or RB (red-blue) imager (e.g., in separate frames), or combination of cameras and/or imagers may be utilized in connection with the disclosed system. It should also be appreciated that not all of the disclosed cameras and other components need to be utilized. For example, all or some of the cameras may be utilized depending upon a variety of factors including objectives of system or user, required completeness of wheel profile, cost or expense, etc.

It should be appreciated that additional cameras may be utilized to even more completely capture images (e.g. from different perspectives, angles, distances, and/or along different stretches of rail) of a wheel. For example, the condition of entire running surface of the wheel may be captured with the several cameras at specified distances. From the images captured by these cameras the entire running surface of the wheel may be assembled.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g., by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

1. A system for capturing, measuring and analyzing rolling stock wheel parameters, comprising:
a first flange camera provided between a first rail and a second rail, wherein the first flange camera is positioned to capture an image of at least a portion of a flange of a first wheel, the flange being located between said first rail and said second rail;
a first internal rim camera provided between said first rail and said second rail, wherein the first internal rim camera is positioned to capture an image of at least a portion of said first wheel;
a first flange throat camera provided between said first rail and said second rail, wherein the first flange throat camera is positioned to capture at least a portion of a flange and area of wheel profile near a flange throat of said first wheel;
a first outer rim camera provided outside the area between said first rail and said second rail, wherein the first outer rim camera is positioned to capture an image of at least a portion of a running surface of said first wheel;
a first field side camera provided outside the area between said first rail and said second rail, wherein the first field side camera is positioned to capture an image of at least a portion of a field side of said first wheel; and
a first endcap camera provided outside the area between said first rail and said second rail, wherein the first end cap camera is positioned to capture an image of at least a portion of an endcap of said first wheel.

2. The system of claim 1, further comprising:
at least one sensor in communication with at least one of the first flange camera, first internal rim camera, first flange throat camera, first outer rim camera, first field side camera, and first endcap camera; and
at least one marker positioned to be at least partially included in any images of at least a portion of the first wheel captured by at least one of the first flange camera, first internal rim camera, first flange throat camera, first outer rim camera, first field side camera, and first endcap camera.

3. The system of claim 1, further comprising a data processing unit in communication with at least one of the first flange camera, first internal rim camera, first flange throat camera, first outer rim camera, first field side camera, and first endcap camera.

4. The system of claim 1, further comprising;
a second flange camera provided between said first rail and said second rail, wherein the second flange camera is positioned to capture an image of at least a portion of a flange of a second wheel, the flange being located between said first rail and said second rail;
a second internal rim camera provided between said first rail and said second rail, wherein the second internal rim camera is positioned to capture an image of at least a portion of said second wheel;
a second flange throat camera provided between said first rail and said second rail, wherein the second flange throat camera is positioned to capture at least a portion of a flange and area of wheel profile near a flange throat of said second wheel;
a second outer rim camera provided outside the area between said first rail and said second rail, wherein the second outer rim camera is positioned to capture an image of at least a portion of a running surface of said second wheel;
a second field side camera provided outside the area between said first rail and said second rail, wherein the second field side camera is positioned to capture an image of at least a portion of a field side of said second wheel; and
a second endcap camera provided outside the area between said first rail and said second rail, wherein the second end cap camera is positioned to capture an image of at least a portion of an endcap of said second wheel.

5. The system of claim 4, further comprising:
at least one sensor in communication with at least one of the second flange camera, second internal rim camera, second flange throat camera, second outer rim camera, second field side camera, and second endcap camera; and
at least one marker positioned to be at least partially included in an image of at least a portion of the first wheel captured by at least one of the second flange camera, second internal rim camera, second flange throat camera, second outer rim camera, second field side camera, and second endcap camera.

6. The system of claim 4, further comprising a data processing unit in communication with at least one of the second flange camera, second internal rim camera, second flange throat camera, second outer rim camera, second field side camera, and second endcap camera.

7. A method of capturing, measuring and analyzing rolling stock wheel parameters, comprising:
capturing, with a first flange camera provided between a first rail and a second rail, an image of at least a portion of a first wheel on said first rail having a flange provided between said first rail and said second rail;
capturing, with a first internal rim camera provided between said first rail and said second rail, an image of at least a portion of said first wheel;
capturing, with a first flange throat camera provided between said first rail and said second rail, an image of at least a portion of a flange and area of wheel profile near a flange throat of said first wheel;
capturing, with a first outer rim camera provided outside the area between said first rail and said second rail, an image of at least a portion of said first wheel, including at least a portion of a running surface of said first wheel;
capturing, with a first field side camera provided outside the area between said first rail and said second rail, an image of at least a portion of a field side of said first wheel; and
capturing, with a first endcap camera provided outside the area between said first rail and said second rail, an image of at least a portion of an endcap of said first wheel.

8. The method of claim 7, further comprising:
sensing the presence of said first wheel with a sensor in communication with at least one of the first flange camera, first internal rim camera, first flange throat camera, first outer rim camera, first field side camera, and first endcap camera; and
positioning at least one marker to be at least partially included in at least one of the images captured by at least one of the first flange camera, first internal rim camera, first flange throat camera, first outer rim camera, first field side camera, and first endcap camera.

9. The method of claim 7, further comprising transmitting to a data processing unit at least one of the images captured by at least one of the first flange camera, first internal rim camera, first flange throat camera, first outer rim camera, first field side camera, and first endcap camera.

10. The method of claim 7, further comprising:
capturing, with a second flange camera provided between said first rail and said second rail, an image of at least a portion of a second wheel on the second rail having a flange provided between said first rail and said second rail;
capturing, with a second internal rim camera provided between said first rail and said second rail, an image of at least a portion of said second wheel;
capturing, with a second flange throat camera provided between said first rail and said second rail, an image of at least a portion of a flange and area of wheel profile near a flange throat of said second wheel;
capturing, with a second outer rim camera provided outside the area between said first rail and said second rail, an image of at least a portion of said second wheel including at least a portion of a running surface of said second wheel;
capturing, with a second field side camera provided outside the area between said first rail and said second rail, an image of at least a portion of a side of said second wheel; and
capturing, with a second endcap camera provided outside the area between said first rail and said second rail, an image of at least a portion of an endcap of said second wheel.

11. The method of claim 10, further comprising:
sensing the presence of said first wheel and/or said second wheel with a sensor in communication with at least one of the first flange camera, second flange camera, first internal rim camera, second internal rim camera, first flange throat camera, second flange throat camera, first outer rim camera, second outer rim camera, first field side camera, second field side camera, first endcap camera, and second endcap camera; and
positioning at least one marker to be at least partially included in at least one of the images captured by at least one of the first flange camera, second flange camera, first internal rim camera, second internal rim camera, first flange throat camera, second flange throat camera, first outer rim camera, second outer rim camera, first field side camera, second field side camera, first endcap camera, and second endcap camera.

12. The method of claim 10, further comprising transmitting to a data processing unit at least one of the images captured by at least one of the first flange camera, second flange camera, first internal rim camera, second internal rim camera, first flange throat camera, second flange throat camera, first outer rim camera, second outer rim camera, first field side camera, second field side camera, first endcap camera, and second endcap camera.

13. A method of providing a system for capturing, measuring and analyzing rolling stock wheel parameters, comprising:
positioning and orienting a first flange camera between a first rail and a second rail to capture an image of at least a portion of a first wheel having a flange provided between said first rail and said second rail;
positioning and orienting a first internal rim camera between said first rail and said second rail to capture an image of at least a portion of said first wheel;
positioning and orienting a first flange throat camera between said first rail and said second rail to capture an image of at least a portion of a flange and area of wheel profile near a flange throat of said first wheel;
positioning and orienting a first outer rim camera outside the area between said first rail and said second rail to capture an image of at least a portion of said first wheel, including at least a portion of a running surface of said first wheel;
positioning and orienting a first field side camera outside the area between said first rail and said second rail to capture an image of at least a portion of said first wheel; and
positioning and orienting a first endcap camera outside the area between said first rail and said second rail to capture an image of at least a portion of an endcap of said first wheel.

14. The method of claim 13, further comprising:
providing at least one sensor, which is in communication with at least one of the first flange camera, first internal rim camera, first flange throat camera, first outer rim camera, first field side camera, and first endcap camera; and
positioning at least one marker, such that the at least one marker is at least partially visible in an image of at least a portion of said first wheel captured by at least one of the first flange camera, first internal rim camera, first flange throat camera, first outer rim camera, first field side camera, and first endcap camera.

15. The method of claim 13, further comprising providing a data processing unit, which is in communication with at least one of the first flange camera, first internal rim camera, first flange throat camera, first outer rim camera, first field side camera, and first endcap camera.

16. The method of claim 13, further comprising:
positioning and orienting a second flange camera between said first rail and a second rail to capture an image of at least a portion of a second wheel on said second rail having a flange provided between said first rail and said second rail;
positioning and orienting a second internal rim camera between said first rail and said second rail to capture an image of at least a portion of said second wheel;
positioning and orienting a second flange throat camera between said first rail and said second rail to capture an image of at least a portion of a flange and area of wheel profile near a flange throat of said second wheel;
positioning and orienting a second outer rim camera provided outside the area between said first rail and said second rail to capture an image of at least a portion of said second wheel including at least a portion of a running surface of said second wheel;
positioning and orienting a second field side camera outside the area between said first rail and said second rail to capture an image of at least a portion of a side of said second wheel; and
positioning and orienting a second endcap camera outside the area between said first rail and said second rail to capture an image of at least a portion of an endcap of said second wheel.

17. The method of claim 16, further comprising:
providing at least one sensor, which is in communication with at least one of the first flange camera, second flange camera, first internal rim camera, second internal rim camera, first flange throat camera, second flange throat camera, first outer rim camera, second outer rim camera, first field side camera, second field side camera, first endcap camera, and second endcap camera; and
positioning at least one marker, such that the at least one marker is at least partially visible in an image of at least a portion of the wheel captured by at least one of the first flange camera, second flange camera, first internal rim camera, second internal rim camera, first flange throat camera, second flange throat camera, first outer rim camera, second outer rim camera, first field side camera, second field side camera, first endcap camera, and second endcap camera.

18. The method of claim 16, further comprising providing a data processing unit, which is in communication with at least one of the first flange camera, second flange camera, first internal rim camera, second internal rim camera, first flange throat camera, second flange throat camera, first outer rim camera, second outer rim camera, first field side camera, second field side camera, first endcap camera, and second endcap camera.
